(19) United States
(12) Patent Application Publication
(10) Pub. No.: US 2026/0148521 A1
(43) Pub. Date: May 28, 2026

(54) Vision Simulator Plugin, System, and Method for Collaborative Design Application

(71) Applicant: Sony Interactive Entertainment LLC, San Mateo, CA (US)

(72) Inventors: Brian Parsons, Oakland, CA (US); Alexander Jeng, Rancho Palos Verdes, CA (US); Ava Liao, London (GB); Jonathan Kvicky, Los Angeles, CA (US); Cooper Birdsall, San Francisco, CA (US); Sean Tieu, Torrance, CA (US)

(21) Appl. No.: 18/960,115

(22) Filed: Nov. 26, 2024

(51) Int. Cl. G06V 10/75; G06F 9/451; G06V 10/56

(52) U.S. Cl. CPC G06V 10/751; G06F 9/451; G06V 10/56

(57) ABSTRACT

A method for simulating vision impairment and evaluating accessibility issues is described. The method includes applying one or more filter to a subject in a screen composition and testing the filtered subject in the screen composition for accessibility issues. An evaluation of the accessibility issues of the screen composition may then be provided.

### FIELD OF THE DISCLOSURE

Aspects of the present disclosure relate to computer user accessibility, more specifically aspects of the present disclosure relate to automated testing and modification of computer interfaces for greater user accessibility.

### BACKGROUND OF THE DISCLOSURE

Human-machine interface design is an often overlooked feature in modern computing. The layout and physical design of the current generation of personal computers and game consoles has been iteratively improved over many system life cycles, to make these systems comfortable and easy to use for the able-bodied consumer. In making these systems comfortable for the able-bodied person, those with less than fully functional faculties may be overlooked.

Improved Hardware accessibility for human-machine interfaces may take the form of specialized physical interfaces such as game controllers, keyboards, mice, joysticks etc. Often these specialized physical interfaces are made custom or customized for the user's particular abilities. In hardware the user of generic input/output (I/O) ports has allowed for the flexibility to use many different kinds of custom physical interfaces with the same system. On the other-hand virtual interface design (UI) is more complex and requires an awareness of usage issues people with disabilities might have. In the past a limited set of tools were provided to users. These tools were client-based and included a screen magnifier, a simple screen reader, and an on-screen keyboard. The client-based nature of the tool means that they were of limited use and could not accommodate certain features like complex user interfaces, complex applications, color contrast issues and certain visual disabilities.

A set of standards have been promulgated to resolve some of these UI issues. These standards are not mandatory, and it is up to the software designers to implement these standards. Thus, there is a patchwork of compliance with these design accessibility standards with some pieces of software ignoring accessibility completely and others in compliance to varying degrees. A major issue with adoption of these standards is that it is a time-consuming process to reach compliance with these standards and require trial and error to reach a compliant result. Additionally, tools like the built-in screen reader would need to be recoded into the software to accommodate more complex UI designs. It is within this context that aspects of the present disclosure arise.

### BRIEF DESCRIPTION OF THE DRAWINGS

The teachings of the present disclosure can be readily understood by considering the following detailed description in conjunction with the accompanying drawings, in which:

FIG. 1 graphically depicts an improved method for automated color contrast evaluation according to aspects of the present disclosure.

FIG. 2 graphically depicts an implementation of the improved method for automated color contrast evaluation using a sliding window according to aspects of the present disclosure.

FIG. 3 is a flow diagram showing the improved method for color contrast evaluation according to an aspect of the present disclosure.

FIG. 4 is a flow diagram depicting a method for accessibility issue detection using impairment filters according to aspects of the present disclosure.

FIG. 5 graphically depicts applying a central vision loss filter to a subject and object having an interactable element in a screen composition according to aspects of the present disclosure.

FIG. 6 graphically shows an example of a visual filter being applied to the subject and, optionally, to an object in the screen composition according to an aspect of the present disclosure.

FIG. 7 graphically depicts an implementation of the method for improved screen reader operation including a graphical user interface (GUI) with which the designer may graphically customize the text list according to aspects of the present disclosure.

FIG. 8 depicts is a flow diagram depicting a method improved screen reader operation by implementing a standard customizable format for readable elements according to aspects of the present disclosure.

FIG. 9 is a block diagram depicting system for determining accessibility issues according to aspects of the present disclosure.

### DESCRIPTION OF THE SPECIFIC EMBODIMENTS

Although the following detailed description contains many specific details for the purposes of illustration, anyone of ordinary skill in the art will appreciate that many variations and alterations to the following details are within the scope of the invention. Accordingly, examples of embodiments of the invention described below are set forth without any loss of generality to, and without imposing limitations upon, the claimed invention.

### Color Contrast Plugin

Creating a UI that is in compliance with color contrast accessibility standards is currently a time-consuming process. Prior art tools for color contrast checking required the user to select a first color and a second color. The prior art tool simply outputs the color contrast ratio between the two selected colors and may also provide whether the contrast ratio is compliant according to some accessibility standards. This is a time-consuming process, and a standard workflow has not been documented for this process. One example work-flow for this time-consuming process is that the designer must determine the location of the object, manually extract colors of background at the selected location for the object, then the designer must determine the colors of the object and enter the extracted color of the background and color of the object into a color check tool or calculate the color ratio by hand and compare the ratio to the accessibility standards. If the color contrast ratio fails, the designer must select additional different colors for the object or find a new location within the background. This iterative process is time consuming.

The improved color contrast checking tool according to aspects of the present disclosure eliminates the need for time consuming selection of colors and in some implementations expedites selection of screen location for objects and/or elements of an object. Additionally prior art color contrast checking did not account for screen effects or filters that may be applied to the background. According to aspects of the present disclosure, the improved color contrast checker may resolve colors directly from screen pixels values instead of from the colors sampled from the background image, thus accounting for any effects that may be applied to the background image after rendering.

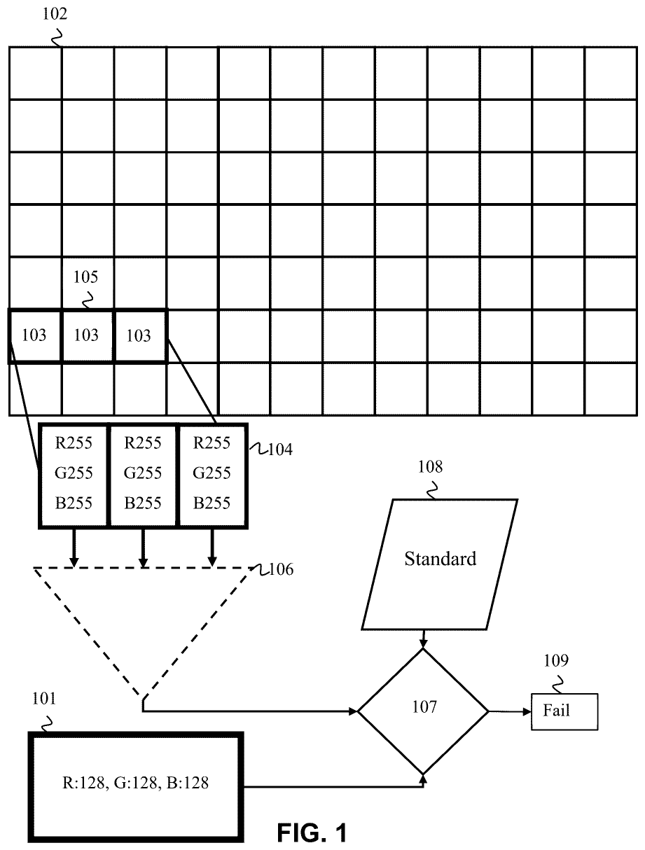

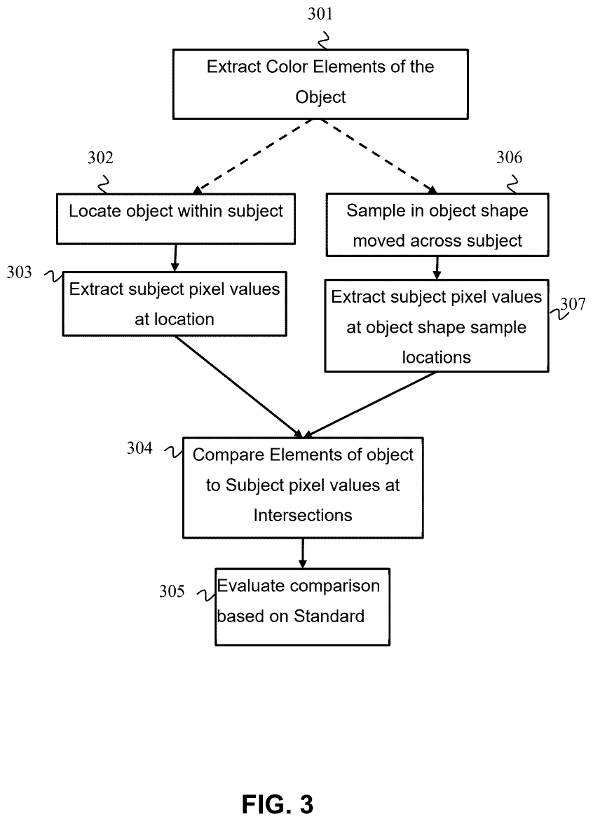

FIG. 1 graphically depicts an improved method for automated color contrast evaluation according to aspects of the present disclosure and FIG. 3 is a flow diagram showing the improved method for color contrast evaluation according to an aspect of the present disclosure.

As shown in FIG. 3, initially one or more color elements that make up the object 301 may be extracted. The color elements may be, for example, samples of color values taken at different locations in the object or, alternatively, screen pixel values of areas within the object after rendering (e.g., after application of one or more filters, effects, etc.). Turning to FIG. 1, the object 101 may be any visible component that is desired by a user to be added to a screen composition. In the simplest non-limiting example, the object may be a single-colored opaque box, such as a box containing text. In the example shown the object 101 is a solid color grey box thus the color elements of the object may be extracted as an RGB value of 128,128,128 or hex color value of #808080. The color elements of the object may be extracted by any suitable method, for example and without limitation each color of the object may be averaged together to generate a single average color element for the box. Alternatively, the color element may be the majority (modal) color value of the object or an average of several of the most common color values in the object. In some implementations the color elements may be extracted from the edge of the object thus ensuring that the edge of the object stands out from the subject when in color compliance. The color elements may be extracted from one or more important areas indicated by the user or averaged from the one or more important areas indicated by the user. In yet other implementations multiple color elements may be extracted from the object. The multiple color elements may be extracted from the most common colors in the object. In other implementations the one or more color elements of the object may be extracted from a color value selection input for object made by the user. In yet other implementations the color elements for the object may be extracted from the subject or from a screen area behind the object. In this implementation the color elements may not be directly visible because they are obscured by the object or some other portion of the screen composition but this may be useful if for example and without limitation the opacity of the object is changeable or moving the view of the screen composition brings the area behind the object withing view.

After selection, extraction of the one or more color elements of the object 301 the object may be located within a subject in screen composition 302. As shown in FIG. 1, the subject 102 may be any still image, portion of an image, image frame in a sequence of image frames, that is part of a screen composition and over which an object may be placed within the screen composition. The subject may be comprised of a single image or multiple images. The subject may include one or more static portions, animated portions, and interactive portions. User interface elements such as a cursor may also be displayed in the screen composition over the subject. Interactable portions are parts of the subject that, when engaged with, can change the subject itself, alter a part of it, affect one or more objects, or create or destroy one or more objects within the screen composition. The subject may be comprised of one or more color samples 103 which are rendered to generate screen pixel values which may be displayed on a display screen (e.g., a computer monitor, television screen, projector, heads up display, etc.). During rendering one or more aftereffects and/or one or more filters may be applied to the color samples to generate the screen pixels values. In some cases, after rendering the screen pixel values may be significantly different from the original color samples in the subject.

In the example depicted in FIG. 1, the object 101 is located at screen position 105. The one or more color samples of the subject at screen position 105 are then rendered and screen pixel values at screen position 105 are taken, thus extracting one or more screen pixels of the subject 303 at the location 105 for the object 101. Here, screen position 105 encompasses three screen pixels that are colored white, and the screen pixel values are given by the representative RGB values of 255, 255, 255. To perform this extraction the coordinate location within the subject may have a screen space transformation applied to it, to generate a screen space coordinate location. A frame buffer may then be queried for the pixel values at the screen space coordinate location.

Next the color elements of the object are compared to the screen pixel values 304. As depicted graphically in FIG. 1, prior to the comparison 107 the screen pixel values 104 may have one or more functions 106 applied to them to place the screen pixels values in a form more suitable for comparison. The one or more functions may include for example and without limitation, taking an average of every screen pixel value, taking an average of the most common screen pixel value (e.g. most common occurring 2 values, 3 values, 4 values, 5 values etc.), choosing the modal pixel value. The functions may produce more than one value for the comparison for example and without limitation the function may choose the two, three, four, etc. most common (modal) screen pixel values. The functions may be locationally aware for example the functions may average neighbor pixel values within a defined segment of the screen pixel values to produce modified pixel values, similarly the modal values may be selected from a defined segment within screen pixel values. In some implementations the location 105 may be larger (e.g. 1, 2, 3, 4, 5, pixels) than the object itself to better accommodate matching of color contrast with an opaque object. The comparison 107 may be made against the one or more modified pixel values or the one or more unmodified screen pixel values depending on the implementation. The comparison 107 may be a simple contrast ratio calculation given by the equation:

$$Contrast ratio = \frac{R L 1 + 0.05}{R L 2 + 0.05}$$

Where RL1 is the Relative Luminance of the lighter color and RL2 is the Relative Luminance of the darker color. The 0.05 represents the contribution of ambient light to the measurement of RL1 and RL2. Relative Luminance is calculated from RGB values (also known as sRGB values by the equation:

$$Relative Luminance = 0.2126 * R + 0.7152 * G + 0.0722 * B$$

Where R, G, and B are parameters defined using the individual RGB color components R_{sRGB}, G_{sRGB}, B_{sRGB}, within the bounds:

$$R = \{ \begin{matrix}\frac{{R}_{sRGB}}{12.92} If {R}_{sRGB} \leq 0.04045 \\ {( \frac{{R}_{sRGB} + 0.055}{1.055} )}^{2.4} Otherwise\end{matrix}$$

$$G = \{ \begin{matrix}\frac{{G}_{sRGB}}{12.92} If {G}_{sRGB} \leq 0.04045 \\ {( \frac{{G}_{sRGB} + 0.055}{1.055} )}^{2.4} Otherwise\end{matrix}$$

$$B = \{ \begin{matrix}\frac{{B}_{sRGB}}{12.92} If {B}_{sRGB} \leq 0.04045 \\ {( \frac{{B}_{sRGB} + 0.055}{1.055} )}^{2.4} Otherwise\end{matrix}$$

To calculate using multiple color elements or multiple screen pixel values or modified pixel values, the color contrast ratio may be calculated for each combination of values or for color elements and pixel values that are near each other within the screen composition. In some instances where one or more color elements overlap other color elements, the color contrast ratio may also be calculated for pixel values that are near each other on the underlying element within the same screen composition. While these calculations have been described for RGB color values it should be understood that they may be adapted for use with any color input type by application of an appropriate conversion to relative luminance values. Alternative color values include CYMK, HSL, and HSC.

Next the calculated color contrast ratio or ratios may be evaluated 305 against a standard 108. For example and without limitation, the standard may be a user defined standard or an international standard such as ICC.1.2022 or ISO 15076-1. Additionally, the color contrast evaluation may include an evaluation based on text size for a given color contrast ratio. As shown here the color contrast ratio for the object 101 in the selected screen location 105 fails the evaluation 109 when evaluated using the standard 108. The evaluation may take the form of a comparison of the color contrast to a threshold value set by the standard. The standard may have different thresholds for different font sizes or other conditions. Where the standards for other conditions are, for example and without limitation, low light conditions, use cases such as road signs, billboards, etc. and high brightness conditions.

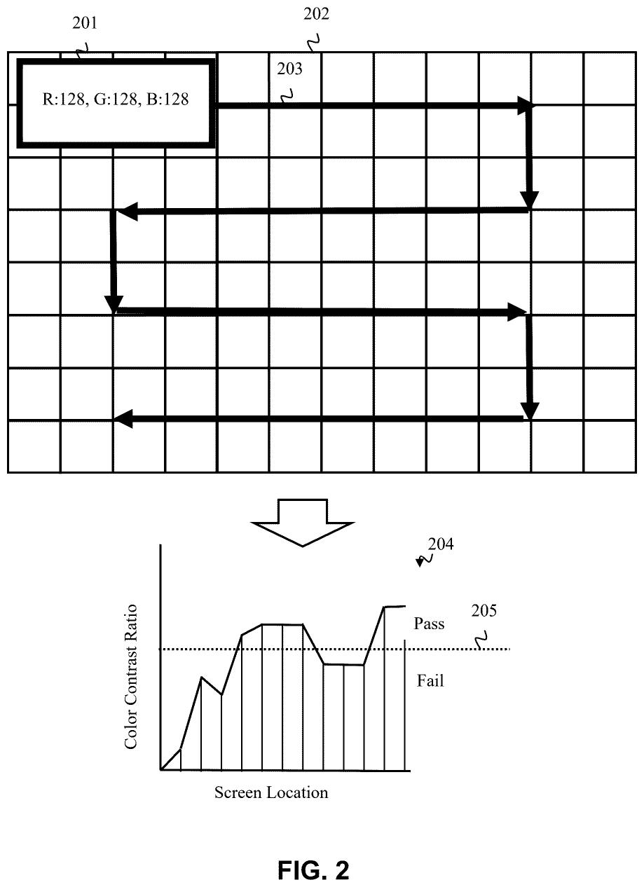

In an alternative implementation depicted in FIG. 2 locations in the subject 202 corresponding to a sliding window having the shape and size of the object 201 may be sampled across subject 307. The sampled locations corresponding to the sliding window may be in an overlapping or non-overlapping pattern. The movement pattern 203 across the subject 202 may be any suitable pattern, here a simple horizontal raster pattern is shown but aspects of the present disclosure are not so limited. The screen locations may be sampled in any suitable pattern, for example in a diagonal raster pattern, a vertical raster pattern, a circular spiral pattern, a square spiral pattern, etc. As discussed above the coordinates of the sampled locations are then transformed by a screen space transformation, to screen pixel location.

The screen pixel color values are then taken at each of the sampled locations to extract the screen pixel values 308. The screen pixel values are then compared to the elements of the object 304 at each screen location. One or more functions may be applied to the extracted screen pixel values at each location in the movement pattern 202 as discussed above to reduce the number of values for the comparison. Alternatively, the one or more pixel values at each location in the movement pattern 202 may be used directly. The comparison may be performed by computation of the color contrast values as discussed above at each location along the movement pattern 202.

Once the color contrast values for each location are computed they may be evaluated against the standard 305. As shown in FIG. 2, the evaluation may be represented graphically 204 as a graph or heat map. In the implementation shown the standard is represented graphically by the threshold line 205 and each location in the screen is represented by a finite position on the X-axis. Color contrast ratio values that exceed the threshold set by the standard are shown at Y-axis locations above the threshold line 205. Alternatively, a heat map may be created where each position in the X and Y axis represents a screen position and the color at each position represents the color contrast ratio.

While portions of the present disclosure discuss implementations with a subject and one or more objects in a screen composition, which may be images, aspects of the present disclosure are not so limited. Aspects of the present disclosure may be applied to a collection of multiple significantly different screen images or successive similar image frames such as in a video sequence. In such cases each different screen image frames or image frame may be treated as a separate screen composition and the method may be performed successively with each image frame. In the case of multiple different screen images, the system may prompt the user to identify the subject of the screen image. The system may generate an evaluation for each screen image or image frame and, in some implementations, a graph or heat map for each screen image or image frame. Additionally, in some implementations the system may output an evaluation based on the collection of screen image or image frames for example a count or average number times in the collection that each location complies with the standard. This evaluation of the collection may be shown graphically as for example and without limitation a color or axis on graph or heat map.

Additionally, according to aspects of the present disclosure the system may automatically change the screen composition to meet the standard. As discussed above, the evaluation may provide locations that at least meet the standard suggestions for locations for the object. In some implementations the system may automatically move the object to a location which at least meets the standard. The user may accept the location or allow the system to move the object to another location which meets the standard. In some implementations the color elements may include a colored interchangeable component in the object or may be part of an interchangeable component. For each interchangeable component in the object, the system may include a predefined library of components having different features including different color elements. These predefined libraries may allow the system to automatically change the interchangeable components to components having color elements that meet the standard. These changes may then be accepted by the designer or rejected in which case another component that having color elements that meet the standard may be selected from the predefined library. To enable this, the user may select a location in the screen where they would like to place the object. Color contrast for an object with the interchangeable component may be generated along with the color contrast for each component in the predefined list for interchangeable components including color elements that cause the color contrast value to fail to meet the standard.

In this way a designer may quickly be able to determine locations in the screen where the object would be acceptable according to the standard, thereby aiding placement of objects on top of a subject within a screen composition.

### Visual Impairment Simulation

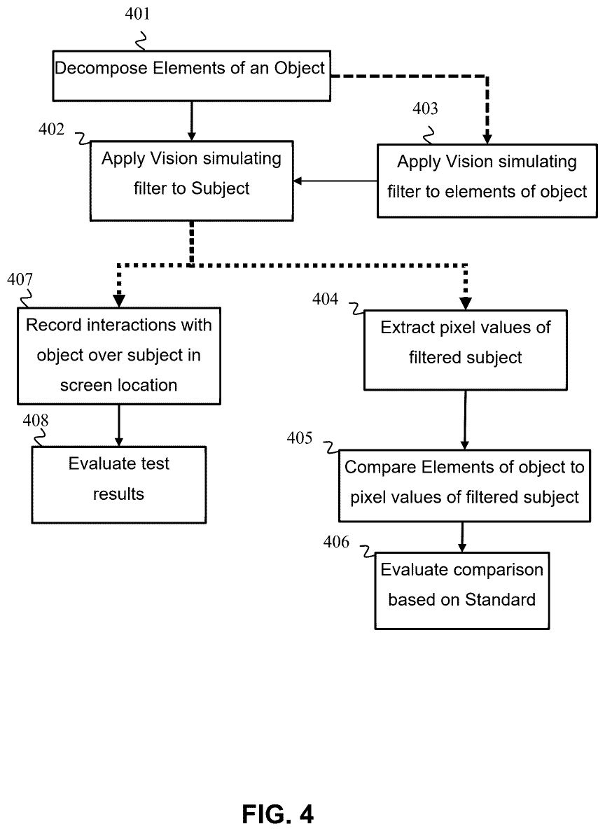

In some implementations according to aspects of the present disclosure, the system may further reduce the workload for designers and provide easier accessibility testing by simulating visual impairments and providing accessibility evaluations during the simulation. As shown in FIG. 4, initially the elements of an object may be extracted as indicated at 401. Here, the elements may be colored elements or may be black and white components within the object such as text or black and white graphics.

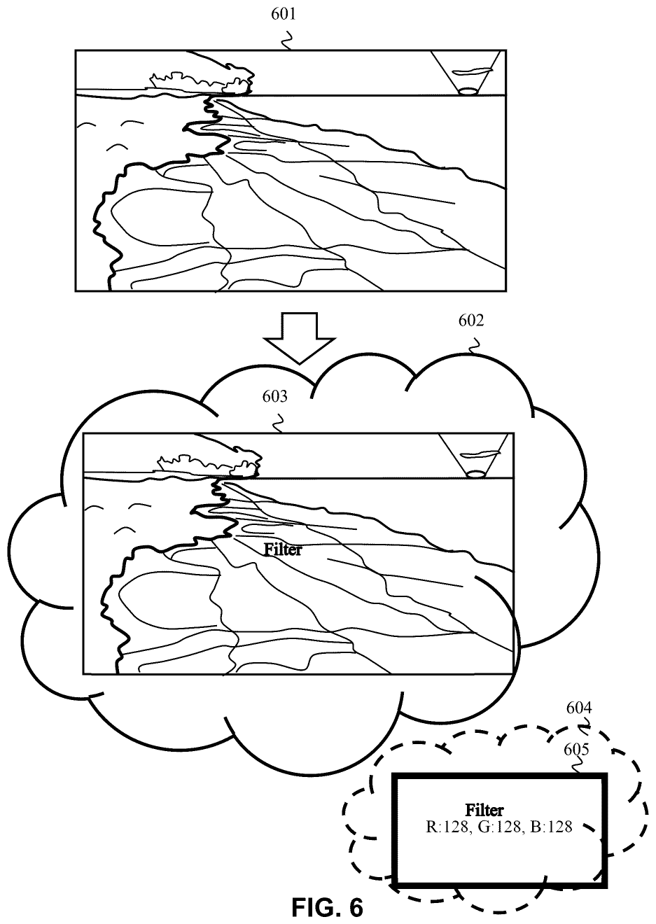

Next, an impairment simulator may be applied to the subject, as indicated at 402. The impairment simulator may be a color impairment filter, for example color inversion, Rod monochromacy, Blue Conc monochromacy, red-green protanomaly color blindness, red-green protanopia color blindness, red-green deuteranomaly color blindness, red-green deuteranopia color blindness, blue-yellow tritanomaly color blindness, blue-yellow tritanopia color blindness, tetrachromacy, or high color contrast. As shown in FIG. 6, the subject 601 may take up the entire screen composition. The filter 602 may be applied over the subject to generate a filtered subject 603 in the frame buffer. In some optional implementations the filter 604 may also be applied to the color elements of the object 605, as indicated at 403 based on location in the screen composition.

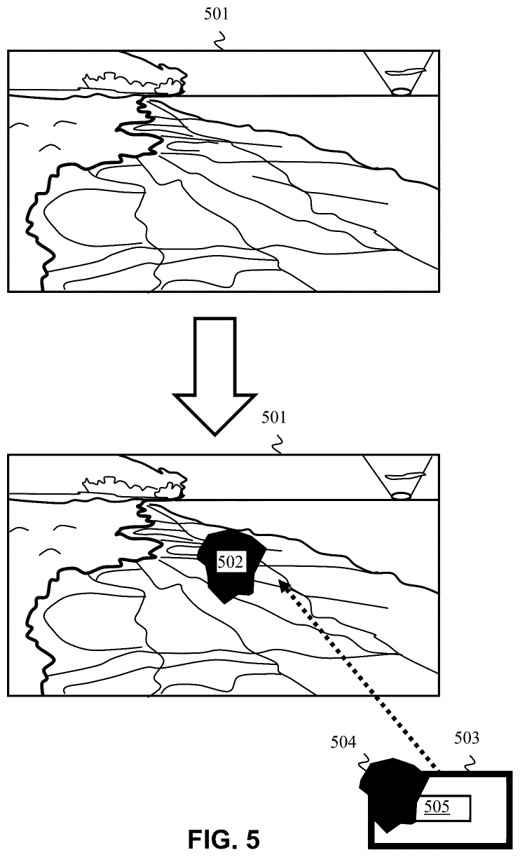

In some implementations the impairment may be simulated by a filter that simulates a type of vision loss, for example and without limitation a central vision loss, peripheral vision loss, blind spot, blurry vision, astigmatism, blind spots, side vision loss, myopia, hyperopia, or presbyopia. FIG. 5 graphically depicts a subject 501 in a screen composition and applying a central vision loss filter 502 to the subject 501. As shown the central vision loss filter 502 may convert all the color values in the affected area to black. Alternatively, the central vision loss filter may convert color values in the affected area to other colors for example and without limitation brown, grey, white and/or blur the background colors heavily. Additionally, while the edges of the filter 502 are well defined in the depiction shown it should be understood that in some limitations the edges of the filters may have a gradient of opacity applied them or may have a gradient blur applied to the background colors. Furthermore, while the implementation shown is a solid opaque shape it should be understood that in some implementations there may areas of transparency in the filter area 502 for example and without limitation the center or other areas of the filter may be completely transparent or have some degree of transparency less than 100% opaque. This may simulate some types of ring shaped vision loss or uneven vision loss. Additionally, as shown when a location for the object 503 is chosen in the filtered area 502 an object filter 504 emulating the filter in the chosen location may be applied to the object at 403. Thus, as shown the object filter 504 has the same shape as the filter over the subject 501 and covers the color elements of the object 503 in the location it would cover if the object was applied over the subject. This may be useful for cases where certain distinct color elements are covered by vision loss and thus may change the compliance of the object at a particular location.

Next a test for accessibility issues may be applied to the screen composition and the subject and/or object after filtering. In some implementations the test may include a color contrast comparison as discussed in FIG. 1, FIG. 2, and FIG. 3. In such implementations the screen pixel values may be extracted for the subject after filtering, as indicated at 404. Additionally, if the one or more elements are filtered, color sample values or screen pixel color values for the one or more color elements may be regenerated. The extraction of the screen pixel value may follow a similar method for extraction to the methods discussed with elements 303 and 307 of FIG. 3.

After extracting the screen pixel values of the filtered subject, the screen pixel values may be compared with the color elements object or filtered object, as indicated at 405. This comparison may be a color contrast comparison calculated as discussed with respect to element 304 of FIG. 3.

Finally, the comparison may be evaluated using a standard, as indicated at 406. This evaluation may be conducted in the manner described with element 305 of FIG. 3. In some implementations, the evaluation may examine text within the screen composition for readability based on a readability standard. The evaluation as such may determine if there are accessibility issues as if a color contrast evaluation fails after application of an impairment filter, then a person with the impairment the filter replicates will have an issues using that particular screen composition.

In an alternative implementation the test for accessibility issues may be based on impaired usability. Testing the accessibility issues may be performed by recording user interactions with the filtered subject or elements of an object or filtered elements of the object over the filtered subject, as indicated at 407. As shown in FIG. 5 one or more elements of the object may be a user interactive element 505. Additionally, in some implementations, the subject itself may include one or more interactive elements. The interactive element may be for example and without limitation, a button, radio button, dial, text entry box, slider, etc. To record user interactions the system may include an on user interaction indicator such a user cursor or a physical input device such as a keyboard, joystick, mouse, eye tracker, touch screen, touch pad, etc. In the case of a user interaction indicator (user cursor) the system may log the location of the cursor within the screen and log the proximity of the cursor to elements and/or interactions with the elements within the screen composition. A new user (tester) may be prompted to navigate through elements of the filtered screen composition to generate the recorded user interactions. For example and without limitation the new user (tester) may be prompted to navigate to a second screen (screen composition) from a first screen or enter a certain input into a particular interactive element (e.g. enter your name in the name text box, click on the submit button, etc.).

After recording the user interactions, the system may evaluate the results for accessibility issues, as indicated at 408. The evaluation may look at the screen position of, screen time and/or a user cursor interaction and/or inputs made by the user to decide if the user is having difficulty with using the screen composition. For example and without limitation, the system may count the number of accidental interactions the user had with the interactive element in the screen composition. The accidental interactions may be for example without limitation mis-clicks, e.g., clicking on (or interacting with) areas of the screen composition that are not the interactive element, The accidental interaction may be for example and without limitation mis-navigation, e.g., navigating to a second incorrect screen, this may be determined by a dwell time on a second page before a user returns to first page (by for example pressing escape or clicking a back button on a browser). In another example the system may evaluate the difficulty of navigating the screen composition by looking at dwell time. By way of example and without limitation, the system may determine a user is having difficulty comprehending the screen if the user's cursor dwells near text or an interactable element for a threshold period of time. The number of issues or times may be compared to a user defined threshold, or a threshold set by a standard to determine if the screen composition fails or passes the accessibility test.

As discussed above with respect to color elements, interactable elements and in some implementations, text may be interchangeable components of the subject and/or object. For each interchangeable component, the system may include a predefined library of components having different features including one or more different sizes, shapes, colors, types etc. These predefined libraries may allow the system to automatically change the interchangeable components to components having features that meet an accessibility standard or reduce accessibility issues. These changes may then be accepted by the designer or rejected in which case another component that having components that meet the standard may be selected from the predefined library. To enable this the user may select a location in the screen they would like to change and interchangeable components within that location may be changed along by running a test for each component in the components list to determine which components pass the accessibility test and exchange the current component in the screen composition with a component that passes test.

In this way a designer may quickly be able to determine locations in the screen where a person with an impairment may have trouble navigating, thereby aiding placement of in the generation of more accessible screen compositions.

### Screen Reader

Another area where the experience for designers concerned about accessibility can be improved is screen readers. Generally, modern systems include a screen reader but the use of a screen reader is hampered by non-standard and non-uniform implementation of current screen readers.

A screen reader is an assistive technology designed to help people with visual impairments or reading disabilities interact with digital content. It translates on-screen information into audio (spoken output) or braille, allowing users to access and navigate software, websites, and documents. Screen readers translate on-screen content into auditory or tactile output, allowing users with visual impairments to navigate, interact with, and consume digital content using keyboard commands, Text To Speech engines, and assistive technologies like braille displays. Some commonly used screen readers for Windows users include JAWS (Job Access With Speech), NVDA (Non Visual Desktop Access), and Narrator. Screen readers for macOS and iOS and Android devices include VoiceOver and TalkBack, respectively. Thus, there are many screen reader implementations, and each one may have a slightly different way of reading the screen. It would be desirable for there to be a standard and customizable way for screen readers to read text on the screen.

In general terms, a screen reader may include hardware and/or software components configured to perform one or more of the following tasks: (1) parsing and interpreting (decomposing) screen content; (2) navigating the content; (3) describing interactive elements; (4) handling dynamic content; and (5) describing graphics and images. According to aspects of the present disclosure one or more the functions may be implemented in a standard customizable format.

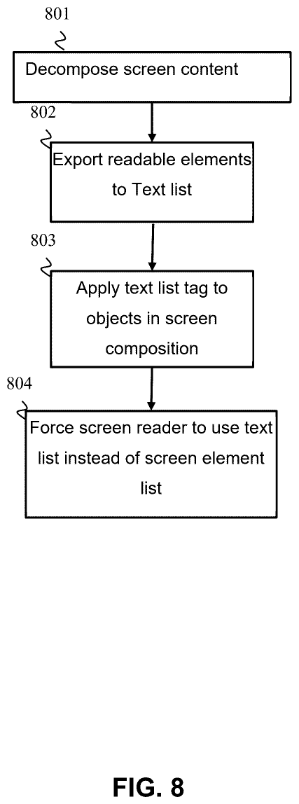

FIG. 8 depicts is a flow diagram depicting a method improved screen reader operation by implementing a standard customizable format for readable elements according to aspects of the present disclosure. Initially, the screen content may decomposed (parsed and interpreted), as indicated at 801. During parsing and interpreting the system may navigate through the content. Each item of readable content is then exported to a text list, as indicated at 802.

To parse and interpret content (decompose), a screen reader may read the underlying code when a user navigates interactive digital content, such as a webpage or user interface. The screen reader may look for content elements such as headings, paragraphs, links, buttons, forms, images, and other content types to convey an order of the content to the user. In some formats such as HTML based screens the screen reader may interact with a document object model (DOM) for the digital content, which is a representation of the content. The DOM typically includes a hierarchical set of nodes that represent a document's structure and content. These nodes may include, among others, document nodes that serve as an entry point to a document hierarchy, element nodes that correspond to individual content elements within the document, attribute nodes that describe element attributes, such as id, class, src, href, text nodes that contain actual text within an element. These nodes may form a hierarchical tree that can be accessed and manipulated using a script, e.g., JavaScript, to create dynamic web experiences. By way of example, and not by way of limitation, the screen reader may read the hierarchy of elements in the DOM to provide context to the user about what is present (e.g., “Heading level 1” or “Button”). To present content to the user, the screen reader may include a text-to-speech (TTS) engine that can convert text into spoken words. In some implementations, the user may customize the TTS engine to adjust speed, pitch, and voice preferences.

There are a number of different ways in which a screen reader may navigate content. For example, a screen reader may be navigated using keyboard commands to move between content elements. By way of example, and not by way of limitation, keyboard shortcuts, such as Tab, arrow keys, or specific commands, such as “H” for headings or “L” for lists may be used. The screen reader may allow a user to jump directly to specific types of content, such as headings, links, form fields, tables or images, instead of reading through content in a linear fashion. A screen reader may track the user's “focus” (the current element the user is interacting with) and announce where the focus is. For example, when the focus is on a button, the screen reader will say “Button” followed by the button's label.

A screen reader may describe interactive elements in a number of different ways. For example, when a user navigates to interactive elements, the screen reader reads aloud the type of element and its label. For instance, for a button that says “Submit,” the screen reader will announce “Button: Submit.” For form fields, it will announce the label and the input type (e.g., “Edit text, First Name”). Screen readers may also use Accessible Rich Internet Applications (ARIA) attributes to understand and describe complex interactive elements. ARIA roles and states tell the screen reader what kind of element it is interacting with (e.g., a menu, dialog box, or slider) and its current state (e.g., open/closed, selected/unselected).

For dynamic or real-time content changes (like notifications, alerts, or auto-updating information), screen readers rely on ARIA “live regions” to notify the screen reader when content changes. This allows a screen reader to announce updates without the user needing to navigate back to that part of the page. A screen reader may use a virtual buffer to capture and interpret content. In complex, dynamic applications (e.g., live chat, online games, or collaborative tools), this buffer refreshes when necessary to present the most up-to-date information.

There are a number of ways in which a screen reader may describe images and graphics. For example some screen readers rely on the “alt” attribute of images to describe visual content. If an image has descriptive alt text (e.g., “Photo of a sunset over the mountains”), the screen reader may read that description to the user. If no alt text is provided, it may say “Image” or skip the image entirely. A screen reader may ignore images marked as decorative (e.g., with empty alt text, alt=“ ”), preventing unnecessary distractions for the user.

Screen readers may further include hardware or software components configured to facilitate user interaction with tables and date. For example, a screen reader may provide methods to navigate tables by row and column, helping users understand the table's structure. By way of example, a screen reader may read the header cells and the data within each cell so users can understand how the information is organized. Furthermore, by reading table headers, a screen reader can announce column and row headings as users move through the table, helping them associate data correctly.

Screen readers may further include hardware and/or software components configured to allow a user to customize the user experience. For example, a screen reader may be configured to allow the user to adjust its voice settings, such as speaking rate, voice, pitch, and volume. Faster readers might set the speed very high to navigate through large amounts of content quickly. Some screen readers may include Braille support features, for use with braille displays. Such a screen reader may send content to the braille display, allowing the user to read the content tactilely. Braille displays may also offer navigation buttons to move through the content. Furthermore, a screen reader may be configured to allow users to create custom keyboard shortcuts or use pre-defined commands to improve efficiency.

Screen readers may include error handling and feedback capabilities. For example, if a user interacts with a form and submits invalid data, the screen reader may be configured to read error messages or warnings to help the user understand what went wrong and how to fix it.

After decomposition of the screen content each item of readable content is then exported to a text list or table, as indicated 802. The text list or table may be any suitable format for example and without limitation a comma separated values (CSV) text list, raw text, excel, JSON, Parquet, SQL database, Feather, HDF5, etc. The text list may be organized as tabular data with a row and/or column for each item of readable content. Additionally, the readable content may be ordered by read order or may have a value (e.g., in a column and/or row) that indicates the read order for the screen reader. Additionally, the text list may include other entries (e.g., in a column and/or row) for example and without limitation entries for: a phonetic pronunciation of the readable content, read speed for the content, vocal cadence for the content, accent with which to read the elements. The text list may also allow skipping reading certain readable content by for example and without limitation having an entry (e.g., in a column and/or row) that flags the system skip reading of that particular content element. Additionally, the text list may include entries (e.g., in a column and/or row) indicating that the screen reader should delay reading one or more content elements.

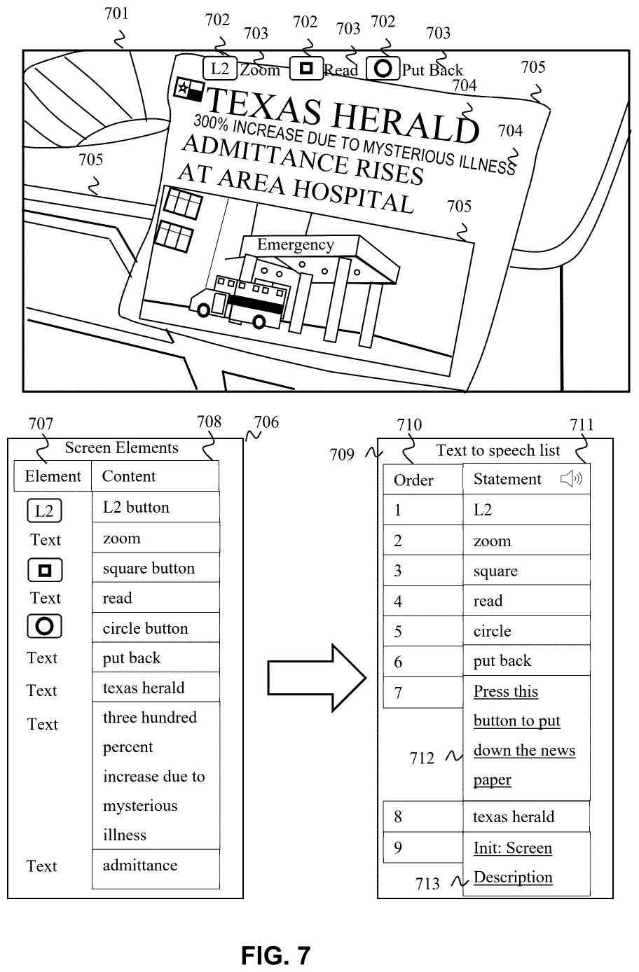

FIG. 7 depicts an implementation of the system including a graphical user interface (GUI) with which the designer may graphically customize the text list. As shown, a screen composition 701 may include different readable elements such as button indicators 702, interface text 703, readable subject text 704, and describable subject screen elements 705. These elements may be graphically decomposed on a designer's screen into temporary screen element list 706. In the screen element list each content item 707 may be listed with its asset or readable text content 708. This temporary screen element list 706 may contain each screen element as it would directly be read by the screen reader. As shown the screen elements in the temporary list may be exported to a text list 709. In this implementation the text list 709 includes entries for read order 710 and the readable element 711. In the implementation shown the readable elements 711 have been modified by the user to improve the flow of the screen reader. For example, the original screen element list the screen reader would read the element “L2” and its label “Button” this is redundant as a user would understand that “L2” refers to the L2 button on the controller, thus the text list has been edited to remove the label. The text list may be edited by a user or the system may include some logic for automated edits to the text list, such as removing labels from certain elements. Additionally, the editable text list allows entry of new content elements for the screen reader to read. As shown the text list 709 has a new entry 712 at read order list 7, this new entry would be read after the screen reader read the UI text “Put back” at read order 6 and is a separate text input not connected to the screen. In this way improved screen readers allow designers to provide additional guidance for those with impairments.

Additionally, in some implementations and as shown in FIG. 7, the text list may allow the system to call a screen description module 713. To call the screen description module the system may include commands which allow the modules to be called from the text list 709. The screen description module here may read an alt text screen label or may describe the screen using a machine learning trained to describe screen for example ScreenAI by Google or Screen2Words. Additionally, it should be understood that in the implementation shown and in some implementations removal of an entry may cause the screen reader to not read the removed element. The text list 709 shown here should be understood to be a graphical representation of text list data structure such as CSV or Excel file as discussed above.

Once the screen elements are exported to the text list, the system may associate the entries in the text list with one or more objects in the screen composition, as indicated at 803 in FIG. 8. The screen composition the screen composition may include objects that have readable screen elements which were decomposed. These readable elements may then be reassociated with the object so that whenever the objects are on screen the text list includes the proper entries. For example and without limitation, in a video game such as the one shown in FIG. 7 Interface elements 702 and interface text 703 may be objects over a subject which may be associated with the entries in text list. This may be performed automatically by, for example and without limitation, retaining screen location for both the object and the readable text. Alternatively, the designer may manually associate entries with objects by for example and without limitation selecting an entry in the text list and an object performing linking command. Additionally, different models within a virtual environment such as a video game may be considered objects and associated with an entry in the text list. For example, and without limitation, in the example of FIG. 7 the newspaper 705 may be a model within the videogame and the text entries may be associated with the newspaper 705 by creating a link between the text entry and the model name for the screen reader. Thus, when the model's name appears in a render list available to the screen reader and the screen reader is active it may pull up the text entries associated with the model name when the model name appears on screen.

Finally, according to aspects of the present disclosure the screen reader is forced to read from the text list instead of decomposing the screen directly, as indicated at 804 in FIG. 8. To implement this, the screen reader may be programmed to read from a text list instead of decomposing the screen elements directly. Alternatively, the system may hook into a programing interface (API) and use commands built into the screen reader to ensure the screen reader uses the text list instead of decomposing the screen elements directly. In yet another alternative implementation the system may insert the text list into a header or other invisible location where it will be decomposed first. The system may then command the screen reader to stop decomposing the screen before reaching the visible elements in the screen composition.

### System

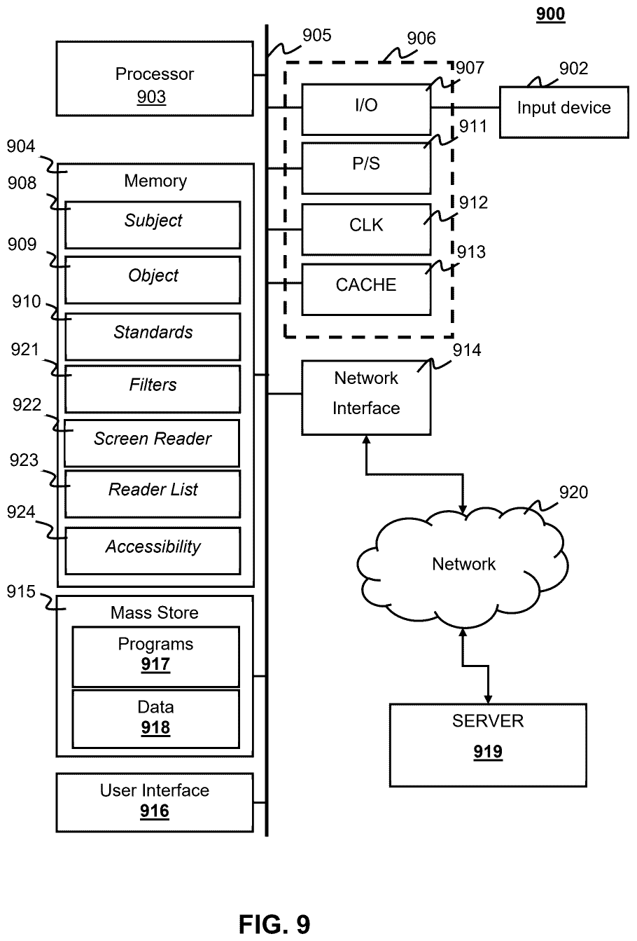

FIG. 9 depicts a system for determining accessibility issues, which may implement methods according to aspects of the present disclosure such as those discussed above with respect to FIG. 3, FIG. 4 and FIG. 8. It should be understood that a system according to aspects of the present disclosure may have sufficient data stored to carry out one or more of the methods discussed above. The system may include a computing device 900 coupled to a user input device 902. The user input device 902 may be a controller, touch screen, microphone, keyboard, mouse, joystick or other device that allows the user to input information including sound data into the system.

The computing device 900 may include one or more processor units 903, which may be configured according to well-known architectures, such as, e.g., single-core, dual-core, quad-core, multi-core, processor-coprocessor, cell processor, and the like. The computing device may also include one or more memory units 904 (e.g., random access memory (RAM), dynamic random-access memory (DRAM), read-only memory (ROM), and the like).

The processor unit 903 may execute one or more programs, portions of which may be stored in the memory 904 and the processor 903 may be operatively coupled to the memory, e.g., by accessing the memory via a data bus 905. The programs may include accessibility applications 924 configured to implement the comparison and evaluation as discussed hereinabove with respect to FIG. 3 and FIG. 4. Additionally the accessibility applications 924 may implement interaction recording as discussed above with respect to FIG. 4. The programs may also include a screen reader program 922 which may either be implemented by a module of the operating system (not shown) or a separate program. In some implementations the screen reader may implement the method for a standard customizable reader list as discussed above with respect to FIG. 8. In such implementations the reader list may simply be a text list. In some alternative implementations the reader list 923 may include an application which implements the method discussed above with respect to FIG. 8 and may hook into the screen reader application 922. In yet other alternative implementations, a separate program such as the accessibility application may implement the method of FIG. 8 and use the data in the reader list 923. The memory units 904 may store data, such as the reader list 923, and standards 910 for evaluation. The memory units 904 may also contain visual information for generating screen compositions such as the subjects 908 and objects 909. The subjects 908 and objects may be stored as image data, image frame data, model data, texture data, array data, etc. Additionally, the memory units 904 may contain one or more filters 910 which may be configured to modify the subject data to for example, emulate impairments as discussed with FIG. 4. The subjects 908, objects 909, standards 910, reader list 923, Screen reader 922, Accessibility applications 924 and filters 921 may be stored as data 918 or programs 617 in the Mass Store 915 or at a server 919 coupled to the Network 920 accessed through the network interface 914. Additionally, the contents of the memory units 904 may be uploaded to the server 919 and the server may run the accessibility applications 924 using the subject data 908 and object data 909 and streaming the operations over the network 920.

The computing device 900 may also include well-known support circuits, such as input/output (I/O) 907, circuits, power supplies (P/S) 911, a clock (CLK) 912, and cache 913, which may communicate with other components of the system, e.g., via the bus 905. The computing device may include a network interface 914. The processor unit 903 and network interface 914 may be configured to implement a local area network (LAN) or personal area network (PAN), via a suitable network protocol, e.g., Bluetooth, for a PAN. The computing device may optionally include a mass storage device 915 such as a disk drive, CD-ROM drive, tape drive, flash memory, or the like, (e.g. a non-transitory computer readable medium) and the mass storage device may store programs and/or data. The computing device may also include a user interface 916 to facilitate interaction between the system and a user. The user interface may include a monitor, television screen, speakers, headphones or other devices that communicate information to the user.

The computing device 900 may include a network interface 914 to facilitate communication via an electronic communications network 920. The network interface 914 may be configured to implement wired or wireless communication over local area networks and wide area networks such as the Internet. The device 900 may send and receive data and/or requests for files via one or more message packets over the network 920. Message packets sent over the network 920 may temporarily be stored in a buffer in memory 904.

While the above is a complete description of the preferred embodiment of the present invention, it is possible to use various alternatives, modifications and equivalents. Therefore, the scope of the present invention should be determined not with reference to the above description but should, instead, be determined with reference to the appended claims, along with their full scope of equivalents. Any feature described herein, whether preferred or not, may be combined with any other feature described herein, whether preferred or not. In the claims that follow, the indefinite article “A”, or “An” refers to a quantity of one or more of the item following the article, except where expressly stated otherwise. The appended claims are not to be interpreted as including means-plus-function limitations, unless such a limitation is explicitly recited in a given claim using the phrase “means for.”

What is claimed is:

1. A method for simulating vision impairment and evaluating accessibility issues, comprising:
applying one or more filter to a subject in a screen composition;
testing the filtered subject in the screen composition for accessibility issues;
providing an evaluation of the accessibility issues of the screen composition.

2. The method of claim 1 wherein applying a filter to the subject in a screen composition includes applying at least one color filter the screen composition.

3. The method of claim 2 wherein testing the filtered subject in the screen composition for accessibility issues includes extracting one or more screen pixel colors from the filtered subject and comparing the one or more screen pixel colors to one or more color elements in a test object to generate a color contrast ratio.

4. The method of claim 3 wherein providing an evaluation of the accessibility issues of the filtered subject includes evaluating the color contrast ratio with a color contrast standard.

5. The method of claim 2 wherein the at least one color filters includes at least one filter selected from the list consisting of: color inversion, Rod monochromacy, Blue Cone monochromacy, red-green protanomaly color blindness, red-green protanopia color blindness, red-green deuteranomaly color blindness, red-green deuteranopia color blindness, blue-yellow tritanomaly color blindness, blue-yellow tritanopia color blindness, tetrachromacy, high color contrast.

6. The method of claim 1 wherein the one or more filters includes a vision loss filter.

7. The method of claim 6 wherein the vision loss filter includes at least one filter for central vision loss, peripheral vision loss, blurry vision, astigmatism, blind spots, side vision loss, myopia, hyperpopia, presbyopia.

8. The method of claim 1 wherein testing the filtered subject in the screen composition includes recording one or more user interactions with the filtered subject.

9. The method of claim 8 wherein the filtered subject includes an interactive element and providing an evaluation of the accessibility issues of the filtered subject includes providing a count of near misses of user interactions with an interactive element of the subject.

10. The method of claim 8 wherein the filtered subject includes an interactive element and providing an evaluation of the accessibility issues of the filtered subject includes providing a count of accidental of user interactions with an interactive element of the subject.

11. The method of claim 10 wherein accidental interactions are determined by a return to previous page action.

12. The method of claim 8 wherein one or more user interactions include a user cursor interaction and providing an evaluation of the accessibility issues of the filtered subject includes a determination of user dwell time near and interactive element of the filter subject.

13. The method of claim 1 wherein the filtered subject includes a sequence of image frames.

14. The method of claim 1 wherein the filtered subject includes a still image.

15. The method of claim 1 wherein filtered image includes readable text.

16. The method of claim 15 wherein testing the filtered subject in the screen composition for accessibility issues includes testing a determination of the readability of text in the filtered image and providing an evaluation of the accessibility issues of the filtered subject includes evaluating the readability of the text based on a readability standard.

17. The method of claim 1 wherein testing the filtered subject in the screen composition for accessibility issues includes running a sliding window over the entire filtered subject and testing the accessibility issues at each location of the sliding window.

18. The method of claim 17 wherein providing an evaluation of the accessibility issues of the filtered subject includes providing a map of locations of accessibility issues for the subject.

19. The method of claim 1 further comprising extracting elements of an object for the screen composition with the subject and determining a location in the screen composition to place the object that satisfies an accessibility standard based on the elements of the object and filtered subject.

20. The method of claim 19 further comprising changing one or more elements of the object to satisfy the accessibility standard.
